(19) United States
(12) Patent Application Publication
(10) Pub. No.: US 2006/0218385 A1
(43) Pub. Date: Sep. 28, 2006

(54) Branch target address cache storing two or more branch target addresses per index

(76) Inventors: Rodney Wayne Smith, Raleigh, NC (US); James Norris Dieffenderfer, Apex, NC (US); Jeffrey Todd Bridges, Raleigh, NC (US); Thomas Andrew Sartorius, Raleigh, NC (US)

Correspondence Address: QUALCOMM INCORPORATED, 5775 MOREHOUSE DR., SAN DIEGO, CA, 92121, US

(21) Appl. No.: 11/089,072

(22) Filed: Mar. 23, 2005

(51) Int. Cl. G06F 9/00

(52) U.S. Cl. 712/238

(57) ABSTRACT

A Branch Target Address Cache (BTAC) stores at least two branch target addresses in each cache line. The BTAC is indexed by a truncated branch instruction address. An offset obtained from a branch prediction offset table determines which of the branch target addresses is taken as the predicted branch target address. The offset table may be indexed in several ways, including by a branch history, by a hash of a branch history and part of the branch instruction address, by a gshare value, randomly, in a round-robin order, or other methods.

### BACKGROUND

The present invention relates generally to the field of processors and in particular to a branch target address cache storing two or more branch target addresses per index.

Microprocessors perform computational tasks in a wide variety of applications. Improving processor performance is a sempitemal design goal, to drive product improvement by realizing faster operation and/or increased functionality through enhanced software. In many embedded applications, such as portable electronic devices, conserving power and reducing chip size are commonly goals in processor design and implementation.

Many modem processors employ a pipelined architecture, where sequential instructions, each having multiple execution steps, are overlapped in execution. This ability to exploit parallelism among instructions in a sequential instruction stream can contribute significantly to improved processor performance. Under certain conditions some processors can complete an instruction every execution cycle.

Such ideal conditions are almost never realized in practice, due to a variety of factors including data dependencies among instructions (data hazards), control dependencies such as branches (control hazards), processor resource allocation conflicts (structural hazards), interrupts, cache misses, and the like. Accordingly a common goal of processor design is to avoid these hazards, and keep the pipeline “full.”

Real-world programs commonly include conditional branch instructions, the actual branching behavior of which may not be known until the instruction is evaluated deep in the pipeline. This branching uncertainty can generate a control hazard that stalls the pipeline, as the processor does not know which instructions to fetch following the branch instruction, and will not know until the conditional branch instruction evaluates. Commonly modern processors employ various forms of branch prediction, whereby the branching behavior of conditional branch instructions is predicted early in the pipeline, and the processor speculatively fetches and executes instructions, based on the branch prediction, thus keeping the pipeline full. If the prediction is correct, performance is maximized and power consumption minimized. When the branch instruction is actually evaluated, if the branch was mispredicted, the speculatively fetched instructions must be flushed from the pipeline, and new instructions fetched from the correct branch target address. Mispredicted branches adversely impact processor performance and power consumption.

There are two components to a conditional branch prediction: a condition evaluation and a branch target address. The condition evaluation is a binary decision: the branch is either taken, causing execution to jump to a different code sequence, or not taken, in which case the processor executes the next sequential instruction following the branch instruction. The branch target address is the address of the next instruction if the branch evaluates as taken. Some branch instructions include the branch target address in the instruction op-code, or include an offset whereby the branch target address can be easily calculated. For other branch instructions, the branch target address must be predicted (if the condition evaluation is predicted as taken).

One known technique of branch target address prediction is a Branch Target Address Cache (BTAC). A BTAC is commonly a fully associative cache, indexed by a branch instruction address (BIA), with each data location (or cache “line”) containing a single branch target address (BTA). When a branch instruction evaluates in the pipeline as taken and its actual BTA is calculated, the BIA and BTA are written to the BTAC (e.g., during a write-back pipeline stage). When fetching new instructions, the BTAC is accessed in parallel with an instruction cache (or I-cache). If the instruction address hits in the BTAC, the processor knows that the instruction is a branch instruction (this is prior to the instruction fetched from the I-cache being decoded), and a predicted BTA is provided, which is the actual BTA of the branch instruction's previous execution. If a branch prediction circuit predicts the branch to be taken, instruction fetching beings at the predicted BTA. If the branch is predicted not taken, instruction fetching continues sequentially. Note that the term BTAC is also used in the art to denote a cache that associates a saturation counter with a BIA, thus providing only a condition evaluation prediction (i.e., branch taken or branch not taken).

High performance processors may fetch more than one instruction at a time from the I-cache. For example, an entire cache line, which may comprise, e.g., four instructions, may be fetched into an instruction fetch buffer, which sequentially feeds them into the pipeline. To use the BTAC for branch prediction on all four instructions would require four read ports on the BTAC. This would require large, complex hardware, and would dramatically increase power consumption.

### SUMMARY

A Branch Target Address Cache (BTAC) stores at least two branch target addresses in each cache line. The BTAC is indexed by a truncated branch instruction address. An offset obtained from a branch prediction offset table determines which of the branch target addresses is taken as the predicted branch target address. The offset table may be indexed in several ways, including by a branch history, by a hash of a branch history and part of the branch instruction address, by a gshare value, randomly, in a round-robin order, or other methods.

One embodiment relates to a method of predicting the branch target address for a branch instruction. At least part of an instruction address is stored. At least two branch target addresses are associated with the stored instruction address. Upon fetching a branch instruction, one of the branch target addresses is selected as the predicted target address for the branch instruction.

Another embodiment relates to a method of predicting branch target addresses. A block of n sequential instructions is fetched, beginning at a first instruction address. A branch target address for each branch instruction in the block that evaluates taken is stored in a cache, such that up to n branch target addresses are indexed by part of the first instruction address.

Another embodiment relates to processor. The processor includes a branch target address cache indexed by part of an instruction address, and operative to store two or more branch target addresses per cache line. The processor further includes a branch prediction offset table operative to store a plurality of offsets. The processor additionally includes an instruction execution pipeline operative to index the cache with an instruction address and select a branch target address from the indexed cache line in response to an offset obtained from the offset table.

### BRIEF DESCRIPTION OF DRAWINGS

FIG. 1 is a functional block diagram of a processor.

FIG. 2 is a functional block diagram of a Branch Target Address Cache and its concomitant circuits.

### DETAILED DESCRIPTION

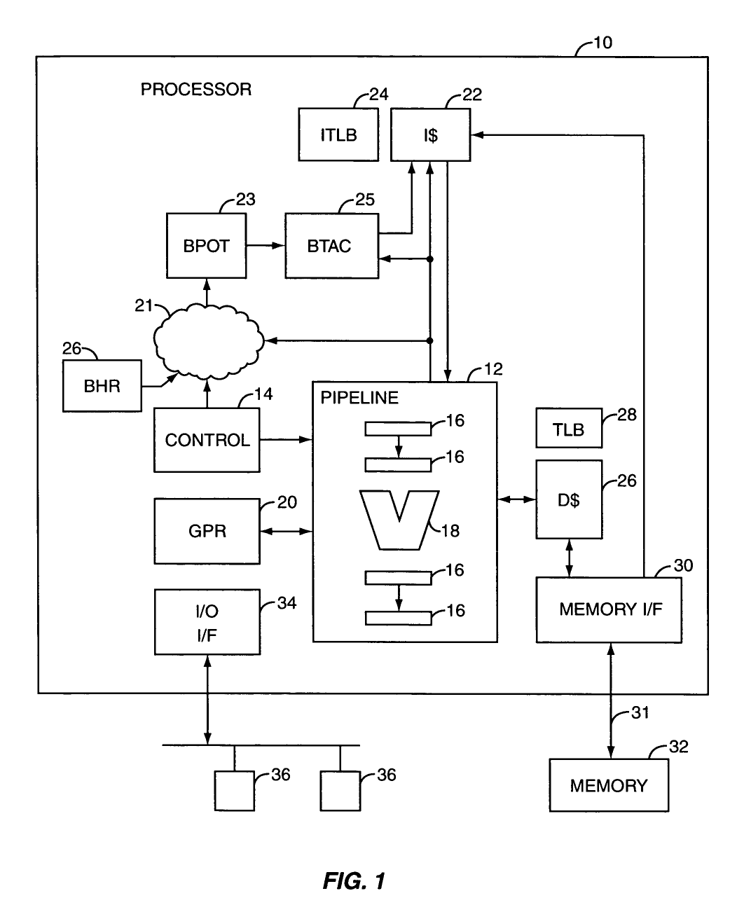

FIG. 1 depicts a functional block diagram of a processor 10. The processor 10 executes instructions in an instruction execution pipeline 12 according to control logic 14. In some embodiments, the pipeline 12 may be a superscalar design, with multiple parallel pipelines. The pipeline 12 includes various registers or latches 16, organized in pipe stages, and one or more Arithmetic Logic Units (ALU) 18. A General Purpose Register (GPR) file 20 provides registers comprising the top of the memory hierarchy.

The pipeline 12 fetches instructions from an instruction cache (I-cache) 22, with memory address translation and permissions managed by an Instruction-side Translation Lookaside Buffer (ITLB) 24. In parallel, the pipeline 12 provides the instruction address to a Branch Target Address Cache (BTAC) 25. If the instruction address hits in the BTAC 25, the BTAC 25 may provide a branch target address to the I-cache 22, to immediately begin fetching instructions from a predicted branch target address. As described more fully below, which of plural potential predicted branch target addresses are provided by the BTAC 25 is determined by an offset from a Branch Prediction Offset Table (BPOT) 23. The input to the BPOT 23, in one or more embodiments, may comprise a hash function 21 including a branch history, the branch instruction address, and other control inputs. The branch history may be provided by a Branch History Register (BHR) 26, which stores branch condition evaluation results (e.g., taken or not taken) for a plurality of branch instructions.

Data is accessed from a data cache (D-cache) 26, with memory address translation and permissions managed by a main Translation Lookaside Buffer (TLB) 28. In various embodiments, the ITLB may comprise a copy of part of the TLB. Alternatively, the ITLB and TLB may be integrated. Similarly, in various embodiments of the processor 10, the I-cache 22 and D-cache 26 may be integrated, or unified. Misses in the I-cache 22 and/or the D-cache 26 cause an access to main (off-chip) memory 32, under the control of a memory interface 30.

The processor 10 may include an Input/Output (I/O) interface 34, controlling access to various peripheral devices 36. Those of skill in the art will recognize that numerous variations of the processor 10 are possible. For example, the processor 10 may include a second-level (L2) cache for either or both the I and D caches 22, 26. In addition, one or more of the functional blocks depicted in the processor 10 may be omitted from a particular embodiment.

Conditional branch instructions are common in most code—by some estimates, as many as one in five instructions may be a branch. However, branch instructions tend not to be evenly distributed. Rather, they are often clustered to implement logical constructs such as if-then-else decision paths, parallel (“case”) branching, and the like. For example, the following code snippet compares the contents of two registers, and branches to target P or Q based on the result of the comparison:
CMP r7, r8 compare the contents of GPR7 and GPR8, and set a condition code or flag to reflect the result of the comparison
BEQ P branch if equal to code label P
BNE Q branch if not equal to code label Q

Because high performance processors 10 often fetch multiple instructions at a time from the I-cache 22, and because of the tendency of branch instructions to cluster within code, if a given instruction fetch includes a branch instruction, there is a high probability that it also includes additional branch instructions. According to one or more embodiments, multiple branch target addresses (BTA) are stored in a Branch Target Address Cache (BTAC) 25, associated with a single instruction address. Upon an instruction fetch that hits in the BTAC 25, one of the BTAs is selected by an offset provided by Branch Prediction Offset Table (BPOT) 23, which may be indexed in a variety of ways.

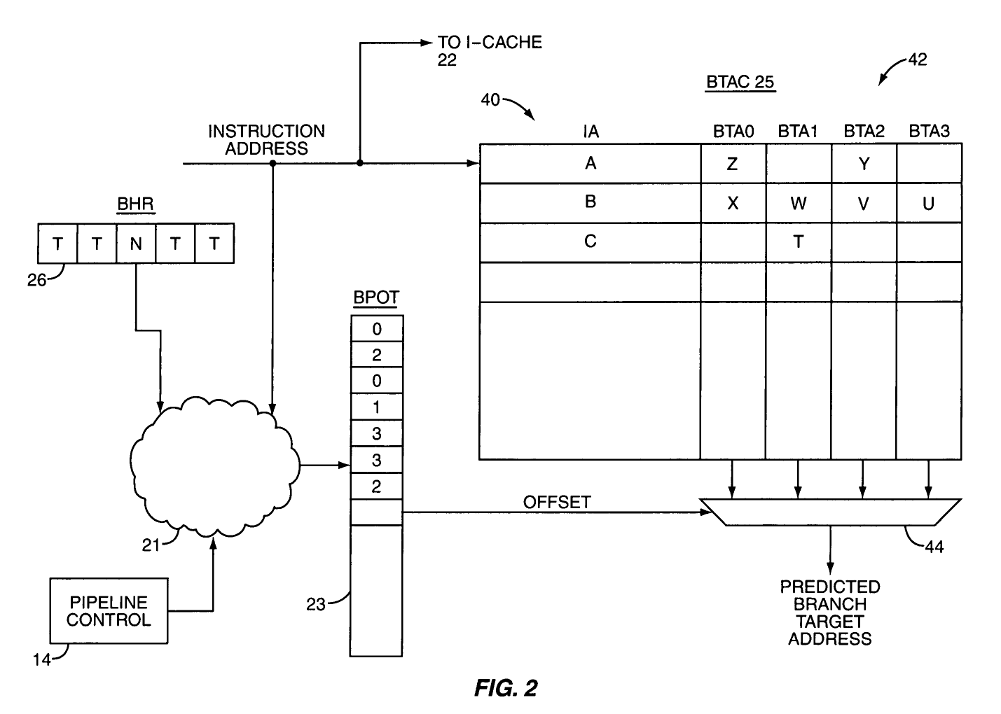

FIG. 2 depicts a functional block diagram of a BTAC 25 and BPOT 23, according to various embodiments. Each entry in the BTAC 25 includes an index, or instruction address field 40. Each entry also includes a cache line 42 comprising two or more BTA fields (FIG. 2 depicts four, denoted BTA0-BTA3). When an instruction address being fetched from the I-cache 22 hits in the BTAC 25, one of the multiple BTA fields of the cache line 42 is selected by an offset, depicted functionally in FIG. 2 as a multiplexer 44. Note that in various implementations, the selection function may be internal to the BTAC 25, or external as depicted by multiplexer 44. The offset is provided by a BPOT 23. The BPOT 23 may store an indicator of which BTA field of the cache line 42 contains the BTA that was last taken under a particular set of circumstances, as described more fully below.

In particular, the state of the BTAC 25 depicted in FIG. 2 may result from various iterations of the following exemplary code (where A-C are truncated instruction addresses and T-Z are branch target addresses):

| | | |
|---|---|---|
| A: | BEQ | Z |
| | ADD | r1, r3, r4 |
| | BNE | Y |
| | ADD | r6, r3, r7 |
| B: | BEQ | X |
| | BNE | W |
| | BGE | V |
| | B | U |
| C: | CMP | r12, r4 |
| | BNE | T |
| | ADD | r3, r8, r9 |
| | AND | r2, r3, r6 |

The code is logically divided into n-instruction blocks (in the depicted example, n=4) by truncating one or more LSBs from the instruction address. If any branch instruction in a block evaluates as taken, a BTAC 25 entry is written, storing the truncated instruction address in the index field 40, and the BTA of the “taken” branch instruction in the corresponding BTA field of the cache line 42. For example, with reference to FIG. 2, at various times, the block of four instructions having the truncated address A was executed. Each branch was evaluated as taken at least once, and the actual respective BTAs were written to the cache line 42, using the LSBs of the instruction address to select the BTAn field (e.g., BTA0 and BTA2). As the instructions corresponding to fields BTA1 and BTA3 are not branch instructions, no data is stored in those fields of the cache line 42 (e.g., a “valid” bit associated with these fields may be 0). At the time each respective BTA is written to the BTAC 25 (e.g., at a write-back pipe stage of the corresponding branch instruction that was evaluated taken), the BPOT 23 is updated to store an offset pointing to the relevant BTA field of the cache line 42. In this example, a value of 0 was stored when the BEQ Z branch was executed, and a value of 2 was stored when the BNE Y branch was executed. These offset values may be stored in positions within the BPOT 23 determined by the processor's condition at the time, as described more fully below.

Similarly, the block of four instructions sharing truncated instruction address B—each instruction in this case being a branch instruction—was also executed numerous times. Each branch was evaluated as taken at least once, and it most recent actual BTA written to the corresponding BTA field of the cache line 42 indexed by the truncated address B. All four BTA fields of the cache line 42 are valid, and each stores a BTA. Entries in the BPOT 23 were correspondingly updated to point to the relevant BTAC 25 BTA field. As another example, FIG. 2 depicts truncated address C and BTA T stored in the BTAC 25, corresponding to the BNE T instruction in block C of the example code. Note that this block of n instructions does not begin with a branch instruction.

As these examples demonstrate, from one to n BTAs may be stored in the BTAC 25, indexed by a single truncated instruction address. On a subsequent instruction fetch, upon hitting in the BTAC 25, one of the up to n BTAs must be selected as the predicted BTA. According to various embodiments, the BPOT 23 maintains a table of offsets that select one of the up to n BTAs for a given cache line 42. An offset is written to the BPOT 23 at the same time a BTA is written to the BTAC 25. The position within the BPOT 23 where an offset is written may depend on the current and/or recent past condition or state of the processor at the time the offset is written, and is determined by logic circuit 21 and its inputs. The logic circuit 21 and its inputs may take several forms.

In one embodiment, the processor maintains a Branch History Register (BHR) 26. The BHR 26, in simple form, may comprise a shift register. The BHR stores the condition evaluation of conditional branch instructions as they are evaluated in the pipeline 12. That is, the BHR 26 stores whether branch instructions are taken (T) or not taken (N). The bit-width of the BHR 26 determines the temporal depth of branch evaluation history maintained.

According to one embodiment, the BPOT 23 is directly indexed by at least part of the BHR 26 to select an offset. That is, in this embodiment, only the BHR 26 is an input to the logic circuit 21, which is merely a “pass through” circuit. For example, at the time the branch instruction BEQ in block A was evaluated as actually taken and the actual BTA of Z was generated, the BHR 26 contained the value (in at least the LSB bit positions) of NNN (i.e., the previous three conditional branches had all evaluated “not taken”). In this case, a 0, corresponding to the field BTA0 of the cache line 42 indexed by the truncated instruction address A, was written to the corresponding position in the BPOT 23 (the uppermost location in the example depicted in FIG. 2). Similarly, when the branch instruction BNE was executed, the BHR 26 contained the value NNT, and a 2 was written to the second position of the BPOT 23 (corresponding to the BTA Y written to the BTA2 field of the cache line 42 indexed by truncated instruction address A).

When the BEQ instruction in the A block is subsequently fetched, it will hit in the BTAC 25. If the state of the BHR 26 at that time is NNN, the offset 0 will be provided by the BPOT 23, and the contents of the BTA0 field of the cache line 42—which is the BTA Z—is provided as the predicted BTA. Alternatively, if the BHR 26 at the time of the fetch is NNT, then the BPOT 23 will provide an offset of 2, and the contents of BTA2, or Y, will be the predicted BTA. The latter case is an example of aliasing, wherein an erroneous BTA is predicted for one branch instruction when the recent branch history happens to coincide with that extant when the BTA for different branch instruction was written.

In another embodiment, logic circuit 21 may comprise a hash function that combines at least part of the BHR 26 output with at least part of the instruction address, to prevent or reduce aliasing. This will increase the size of the BPOT 23. In one embodiment, the instruction address bits may be concatenated with the BHR 26 output, generating a BPOT 23 index analogous to the gselect predictor known in the art, as related to branch condition evaluation prediction. In another embodiment, the instruction address bits may be XORed with the BHR 26 output, resulting in a gshare-type BPOT 23 index.

In one or more embodiments, one or more inputs to the logic circuit 21 may be unrelated to branch history or the instruction address. For example, the BPOT 23 may be indexed incrementally, generating a round-robin index. Alternatively, the index may be random. One or more of these types of inputs, for example generated by the pipeline control logic 14, may be combined with one or more of the index-generating techniques described above.

According to one or more embodiments describe herein, accesses to a BTAC 25 may keep pace with instruction fetching from an I-cache, by matching the number of BTAn fields in a BTAC 25 cache line 42 to the number of instructions in an I-cache 22 cache line. To select one of the up to n possible BTAs as a predicted BTA, the processor condition, such as recent branch history, may be compared to that extant at the time the BTA(s) were written to the BTAC 25. Various embodiments of indexing a BPOT 23 to generate an offset for BTA selection provide a rich set of tools that may be optimized for particular architectures or applications.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of predicting the branch target address for a branch instruction, comprising:
storing at least part of an instruction address;
associating at least two branch target addresses with the stored instruction address; and
upon fetching a branch instruction, selecting one of the branch target addresses as the predicted target address for the branch instruction.

2. The method of claim 1 wherein storing at least part of an instruction address comprises writing at least part of the instruction address as an index in a cache.

3. The method of claim 2 wherein associating at least two branch target addresses with the instruction address comprises, upon executing each of the at least two branch instructions, writing the branch target address of the respective branch instruction as data in a cache line indexed by the index.

4. The method of claim 1 further comprising accessing a branch prediction offset table to obtain an offset, and wherein selecting one of the branch target addresses as the predicted target address comprises selecting the branch target address corresponding to the offset.

5. The method of claim 4 wherein accessing a branch prediction offset table comprises indexing the branch prediction offset table by a branch history.

6. The method of claim 4 wherein accessing a branch prediction offset table comprises indexing the branch prediction offset table by a hash function of a branch history and the instruction address.

7. The method of claim 4 wherein accessing a branch prediction offset table comprises randomly indexing the branch prediction offset table.

8. The method of claim 4 wherein accessing a branch prediction offset table comprises incrementally indexing the branch prediction offset table to generate a round-robin selection.

9. The method of claim 4 further comprising writing an offset to the branch prediction offset table when a branch instruction evaluates taken, the offset indicating which of the at least two branch target addresses is associated with the taken branch instruction.

10. The method of claim 1 wherein storing at least part of an instruction address comprises truncating the instruction address by at least one bit such that the truncated instruction address references a block of n instructions.

11. A method of predicting branch target addresses, comprising:
fetching a block of n sequential instructions referenced by a truncated instruction address; and
storing in a cache, a branch target address for each branch instruction in the block that evaluates taken, such that up to n branch target addresses are indexed by the truncated instruction address.

12. The method of claim 11 further comprising, upon subsequently fetching one of the branch instructions in the block, selecting a branch target address from the cache.

13. The method of claim 12 wherein selecting a branch target address from the cache comprises:
obtaining an offset from an offset table;
indexing the cache with the truncated instruction address; and
selecting one of the up to n branch target addresses according to the offset.

14. The method of claim 13 wherein obtaining an offset from an offset table comprises indexing the offset table with a branch history.

15. A processor, comprising:
a branch target address cache indexed by a truncated instruction address, and
operative to store two or more branch target addresses per cache line;
a branch prediction offset table operative to store a plurality of offsets; and
an instruction execution pipeline operative to index the cache with a truncated instruction address and to select a branch target address from the indexed cache line in response to an offset obtained from the offset table.

16. The processor of claim 15 further comprising an instruction cache having a an instruction fetch bandwidth of n instructions, and wherein the truncated instruction address addresses a block of n instructions.

17. The processor of claim 16, wherein the branch target address is operative to store up to n branch target addresses per cache line.

18. The processor of claim 15 further comprising a branch history register operative to store an indication of the condition evaluation of a plurality of conditional branch instructions, the contents of the branch history register indexing the branch prediction offset table to obtain the offset to select a branch target address from the indexed cache line.

19. The processor of claim 18 wherein the contents of the branch history register are combined with the truncated instruction address prior to indexing the branch prediction offset table.
